(19) United States
(12) Patent Application Publication
(10) Pub. No.: US 2013/0280511 A1
(43) Pub. Date: Oct. 24, 2013

(54) Tire Cover Comprising a Self-Adherent Composite Reinforcement

(71) Applicants: Vincent Abad, Clermont-Ferrand Cedex 9 (FR); Sébastien Rigo, Clermont-Ferrand Cedex 9 (FR); Emmanuel Custodero, Clermont-Ferrand Cedex 9 (FR)

(72) Inventors: Vincent Abad, Clermont-Ferrand Cedex 9 (FR); Sébastien Rigo, Clermont-Ferrand Cedex 9 (FR); Emmanuel Custodero, Clermont-Ferrand Cedex 9 (FR)

(73) Assignees: Michelin Recherche et Technique S.A., Granges-Paccot (CH); COMPAGNIE GENERALE DES ESTABLISSEMENTS MICHELIN, Clermont-Ferrand (FR)

(21) Appl. No.: 13/825,926

(22) PCT Filed: Sep. 16, 2011
(86) PCT No.: PCT/EP11/66113

§ 371 Date: Jul. 10, 2013

(30) Foreign Application Priority Data
Sep. 23, 2010 (FR) 10/57666

(51) Int. Cl. C08K 3/08

(52) U.S. Cl. CPC C08K 3/08
USPC 428/220; 428/379; 524/439

(57) ABSTRACT

Pneumatic tire comprising a composite reinforcer (R-2) that is self-adhesive by curing to a diene rubber matrix, comprising: one or more reinforcing thread(s) (20), for example a carbon steel cord; covering said thread, individually each thread or collectively several threads, a layer of a thermoplastic polymer composition comprising on the one hand a thermoplastic polymer, the glass transition temperature of which is positive, on the other hand an unsaturated thermoplastic stirene elastomer, the glass transition temperature of which is negative.

### FIELD OF THE INVENTION

The field of the present invention is that of reinforcing elements or reinforcers, notably metallic ones, for pneumatic tires.

The present invention relates more particularly to pneumatic tires reinforced with reinforcers of the hybrid or composite type that consist of at least one core, in particular a metal core, said core being covered or sheathed by a layer or sheath of a thermoplastic material.

### PRIOR ART

The sheathing of metallic reinforcers with thermoplastic materials, such as for example a polyamide or polyester, has been known for a very long time, especially so as to protect these reinforcers from various types of external attack such as oxidation or abrasion, or else for the purpose of structurally stiffening, of joining together, various groups of threads or thread assemblies such as cords, and thus increasing particularly their buckling resistance.

Such composite reinforcers, together with their use in rubber articles such as pneumatic tires, have been described in many patent documents.

Patent application EP 0 962 562 has for example described a reinforcer, made of steel or aramid textile, sheathed by a thermoplastic material such as a polyester or polyamide, for the purpose of improving its abrasion resistance.

Patent application FR 2 601 293 has described the sheathing of a metal cord with a polyamide so as to use it as a bead wire in a pneumatic tire bead, this sheathing advantageously enabling the shape of this bead wire to adapt to the structure and to the operating conditions of the bead of the pneumatic tire that it reinforces.

Patent documents FR 2 576 247 and U.S. Pat. No. 4,754,794 have also described metal cords or threads that can be used as a bead wire in a pneumatic tire bead, these threads or cords being doubly-sheathed or even triply-sheathed by two or even three different thermoplastic materials (e.g. polyamides) having different melting points, with the purpose, on the one hand, of controlling the distance between these threads or cords and, on the other hand, of eliminating the risk of wear by rubbing or of corrosion, in order to use them as a bead wire in a pneumatic tire bead.

These reinforcers thus sheathed with a polyester or polyamide material have, apart from the aforementioned advantages of corrosion resistance, abrasion resistance and structural rigidity, the not insignificant advantage of them being able to be subsequently bonded to diene rubber matrices using simple textile adhesives called RFL (resorcinol-formaldehyde-latex) adhesives comprising at least one diene elastomer, such as natural rubber, which adhesives are known to provide satisfactory adhesion between textile fibres, such as polyester or polyamide fibres, and a diene rubber.

Thus, it may be advantageous to use metal reinforcers not coated with adhesive metal layers, such as with brass, and also surrounding rubber matrices containing no metal salts, such as cobalt salts, which are necessary as is known for maintaining the adhesive properties over the course of time but which significantly increase, on the one hand, the cost of the rubber matrices themselves and, on the other hand, their oxidation and aging sensitivity (see for example the patent application WO 2005/113666).

However, the above RFL adhesives are not without drawbacks: in particular they contain as base substance formaldehyde, a substance which it is desirable long-term to eliminate from adhesive compositions because of the recent changes in European regulations regarding this type of product.

Thus, pneumatic tire manufacturers are presently seeking new adhesive systems or new reinforcers that enable all or some of the aforementioned drawbacks to be alleviated.

### BRIEF DESCRIPTION OF THE INVENTION

Now, over the course of their research, the applicants have discovered a composite reinforcer which requires no sizing treatment in order to adhere to rubber, in a certain sense of the type self-adhesive by curing, and which consequently enables the above objective to be achieved.

As a consequence, a first subject of the invention is a pneumatic tire comprising a composite reinforcer comprising:
one or more reinforcing thread(s);
covering said thread, individually each thread or collectively several threads, a layer of a thermoplastic polymer composition comprising on the one hand a thermoplastic polymer, the glass transition temperature of which is positive, on the other hand an unsaturated thermoplastic stirene elastomer, the glass transition temperature of which is negative.

Unexpectedly, it has been found that the presence of this unsaturated thermoplastic stirene elastomer makes it possible to ensure that the composite reinforcer adheres directly (i.e. without RFL adhesive or any other adhesive) and strongly to a diene elastomer matrix or composition such as those widely used in pneumatic tires.

The present invention also relates to the use of the composite reinforcer above as reinforcing element for pneumatic tires, especially those intended to be fitted onto motor vehicles of the passenger type, SUVs (“Sport Utility Vehicles”), two-wheel vehicles (especially bicycles and motorcycles), aircraft, or industrial vehicles chosen from vans, “heavy” vehicles, i.e. underground trains, buses, heavy road transport vehicles (lorries, tractors, trailers), off-road vehicles, such as agricultural or civil engineering machines, and other transport or handling vehicles.

The invention and its advantages will be readily understood in the light of the description and the embodiments that follow, in conjunction with the figures relating to these embodiments which show schematically:

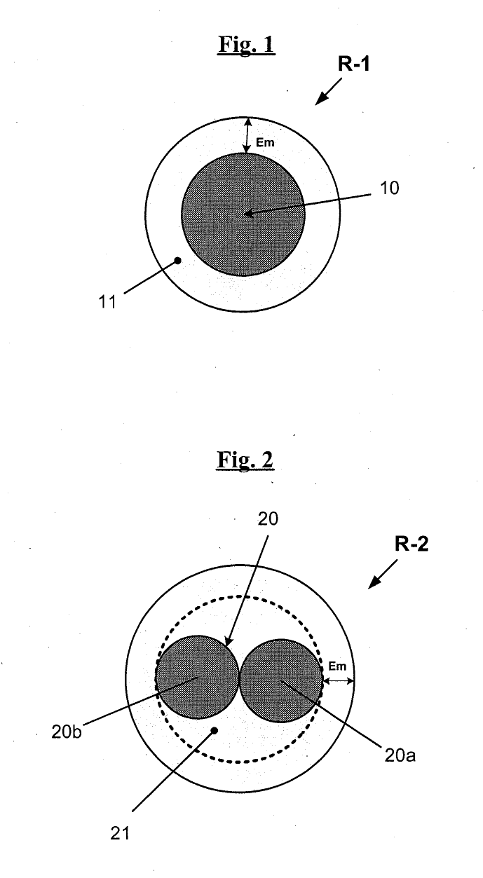

in cross section, an example of a composite reinforcer suitable for the pneumatic tire according to the invention (FIG. 1);

in cross section, another example of a reinforcer suitable for the pneumatic tire according to the invention (FIG. 2);

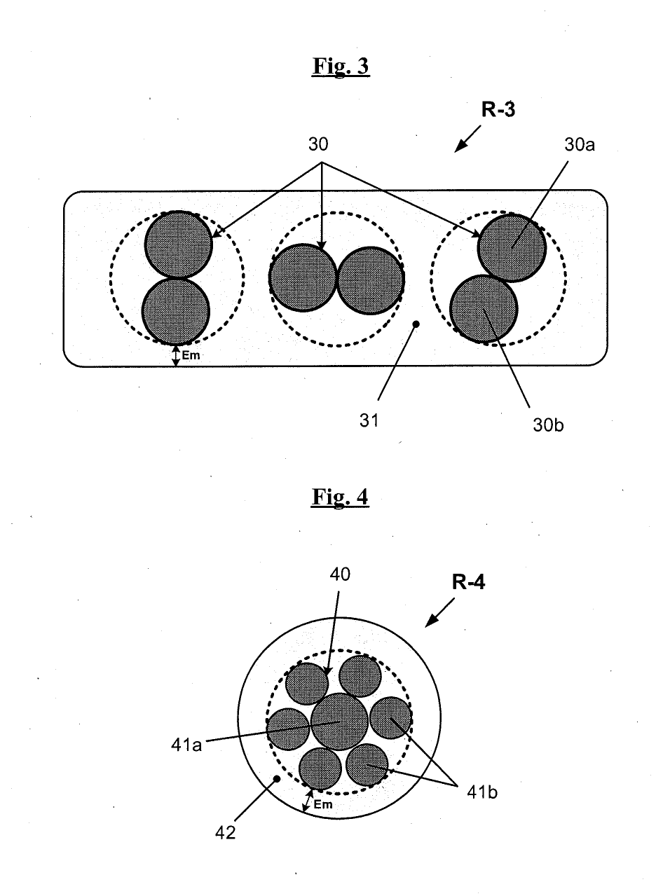

in cross section, another example of a reinforcer suitable for the pneumatic tire according to the invention (FIG. 3);

in cross section, another example of a reinforcer suitable for the pneumatic tire according to the invention (FIG. 4); and

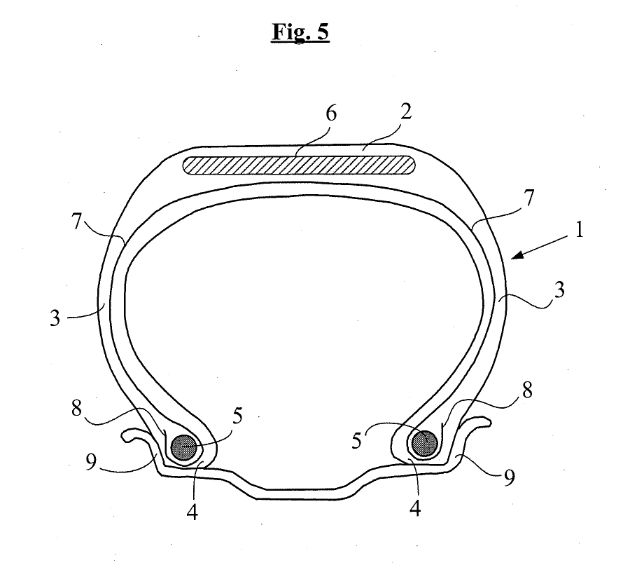

in radial section, a pneumatic tire having a radial carcass reinforcement, in accordance with the invention, incorporating such a composite reinforcer (FIG. 5).

### DETAILED DESCRIPTION OF THE INVENTION

In the present description, unless expressly indicated otherwise, all the percentages (%) indicated are percentages by weight.

Moreover, any range of values denoted by the expression “between a and b” represents the range of values starting from more than a to less than b (i.e. with the limits a and b excluded), whereas any range of values denoted by the expression “from a to b” means the range of values starting from a and going up to b (i.e. including the strict limits a and b).

The composite reinforcer of the pneumatic tire of the invention, capable of adhering directly, by curing, to an unsaturated rubber composition, therefore has the essential features of comprising:
at least one reinforcing thread (i.e. one or more reinforcing threads);
covering individually said thread, each thread or collectively several threads, a layer of a thermoplastic polymer composition comprising on the one hand a thermoplastic polymer, the glass transition temperature (denoted hereafter by Tg₁) of which is positive (i.e. greater than 0° C.), on the other hand an unsaturated thermoplastic stirene elastomer, the glass transition temperature (denoted hereafter by Tg₂) of which is negative (i.e. less than 0° C.).

In other words, this composite reinforcer comprises a single reinforcing thread or several reinforcing threads, each reinforcing thread being covered by a layer (monolayer) or sheath of thermoplastic polymer composition. The structure of this reinforcer is described in detail below.

In the present application, the term “reinforcing thread” is understood in general to mean any elongate element of great length relative to its cross section, whatever the shape, for example circular, oblong, rectangular, square, or even flat, of this cross section, it being possible for this thread to be straight or not straight, for example twisted or wavy.

This reinforcing thread may take any known form. For example, it may be an individual monofilament of large diameter (for example and preferably equal to or greater than 50 μm), an individual ribbon, a multifilament fibre (consisting of a plurality of individual filaments of small diameter, typically less than 30 μm), a textile folded yarn formed from several fibres twisted together, a textile or metal cord formed from several fibres or monofilaments cabled or twisted together, or else a band or strip comprising several of these monofilaments, fibres, folded yarns or cords grouped together, for example aligned along a main direction, whether straight or not.

The or each reinforcing thread has a diameter preferably smaller than 5 mm, especially in the range from 0.1 to 2 mm.

Preferably, the reinforcing thread is a metal reinforcing thread, especially a carbon steel wire such as those used in steel cords for tires. However, it is of course possible to use other types of steel, for example stainless steel. When a carbon steel is used, its carbon content is preferably between 0.4% and 1.2%, especially between 0.5% and 1.1%. The invention applies in particular to any steel of the steel cord type having a standard or NT (“Normal Tensile”) strength, a high or HT (“High Tensile”) strength, a very high or SHT (“Super High Tensile”) strength or an ultra-high or UHT (“Ultra High Tensile”) strength.

The steel could be coated with an adhesive layer, such as a layer of brass or zinc. However, advantageously a bright, i.e. uncoated, steel may be used. Furthermore, by virtue of the invention, the rubber composition intended to be reinforced by a metal reinforcer according to the invention no longer requires the use in its formulation of metal salts such as cobalt salts.

The thermoplastic polymer composition constituting the layer or sheath above firstly comprises a thermoplastic polymer having by definition a positive Tg (denoted by Tg₁), preferably greater than +20° C. and more preferably greater than +30° C. Moreover, the melting point (denoted by Tm) of this thermoplastic polymer is preferably greater than 100° C., more preferably greater than 150° C. and especially greater than 200° C.

This thermoplastic polymer is preferably selected within the group consisting of polyamides, polyesters and polyimides, more particularly within the group consisting of aliphatic polyamides and polyesters. Among polyesters, mention may for example be made of PET (polyethylene terephthalate), PEN (polyethylene naphthalate), PBT (polybutylene terephthalate), PBN (polybutylene naphthalate), PPT (polypropylene terephthalate), and PPN (polypropylene naphthalate). Among aliphatic polyamides, mention may in particular be made of the polyamides 4,6, 6, 6,6, 11 and 12. This thermoplastic polymer is preferably an aliphatic polyamide, more preferably a polyamide 6 or a polyamide 11.

The second essential constituent of the thermoplastic polymer composition is an unsaturated thermoplastic stirene elastomer having by definition a negative Tg (Tg₂), preferably less than −20° C. and more preferably less than −30° C.

Thus, and according to a preferred embodiment of the invention, the difference in glass transition temperatures (Tg₁-Tg₂) between the thermoplastic polymer and the unsaturated TPS elastomer is greater than 40° C., more preferably greater than 60° C.

It will be recalled here that TPS (thermoplastic stirene) elastomers are thermoplastic elastomers in the form of stirene-based block copolymers. These thermoplastic elastomers, having an intermediate structure between thermoplastic polymers and elastomers, are made up, as is known, from polystirene hard sequences linked by elastomer soft sequences, for example polybutadiene, polyisoprene or poly(ethylene/butylene) sequences.

This is why, as is known, TPS copolymers are generally characterized by the presence of two glass transition peaks, the first (lower, negative temperature, corresponding to Tg₂) peak relating to the elastomer block of the TPS copolymer while the second (higher, positive temperature, typically at around 80° C.) peak relating to the thermoplastic (stirene block) part of the TPS copolymer.

These TPS elastomers are often tri-block elastomers with two hard segments linked by a soft segment. The hard and soft segments may be arranged in a linear fashion, or in a star or branched configuration. These TPS elastomers may also be di-block elastomers with a single hard segment linked to a soft segment. Typically, each of these segments or blocks contains a minimum of more than 5, generally more than 10, base units (for example stirene units and isoprene units in the case of a stirene/isoprene/stirene block copolymer).

As a reminder, one essential feature of the TPS elastomer used in the composite reinforcer according to the invention is the fact that it is unsaturated. By the expression “TPS elastomer” is understood by definition, and as is well known, a TPS elastomer that contains ethylenically unsaturated groups, i.e. it contains carbon-carbon double bonds (whether conjugated or not). Conversely, a saturated TPS elastomer is of course a TPS elastomer that contains no such double bonds.

Preferably, the unsaturated elastomer is a copolymer comprising stirene (i.e. polystirene) blocks and diene (i.e. polydiene) blocks, especially isoprene (polyisoprene) or butadiene (polybutadiene) blocks. Such an elastomer is selected in particular within the group consisting of stirene/butadiene (SB), stirene/isoprene (SI), stirene/butadiene/butylene (SBB), stirene/butadiene/isoprene (SBI), stirene/butadiene/stirene (SBS), stirene/butadiene/butylene/stirene (SBBS), stirene/isoprene/stirene (SIS), stirene/butadiene/isoprene/stirene (SBIS) block copolymers and blends of these copolymers.

More preferably, this unsaturated elastomer is a copolymer of the tri-block type, selected within the group consisting of stirene/butadiene/stirene (SBS), stirene/butadiene/butylene/stirene (SBBS), stirene/isoprene/stirene (SIS), stirene/butadiene/isoprene/stirene (SBIS) block copolymers and blends of these copolymers; more particularly, it is an SBS or SIS, especially an SBS.

According to another preferred embodiment of the invention, the stirene content in the unsaturated TPS elastomer is between 5 and 50%. Outside the range indicated, there is a risk of the intended technical effect, namely an adhesion compromise with respect, on the one hand, to the layer of the thermoplastic polymer and, on the other hand, to the diene elastomer to which the reinforcer is moreover intended, no longer being optimal. For these reasons, the stirene content is more preferably between 10 and 40%.

The number-average molecular weight (Mₙ) of the TPS elastomer is preferably between 5000 and 500,000 g/mol, more preferably between 7000 and 450,000. The number-average molecular weight (Mₙ) of the TPS elastomers is determined, in a known manner, by SEC (steric exclusion chromatography). The specimen is firstly dissolved in tetrahydrofuran with a concentration of about 1 g/l and then the solution is filtered on a filter of 0.45 μm porosity before injection. The apparatus used is a WATERS Alliance chromatograph. The elution solvent is tetrahydrofuran, the flow rate is 0.7 ml/min, the temperature of the system is 35° C. and the analysis time is 90 min. A set of four WATERS “STYRAGEL” columns (an HMW7 column, an HMW6E column and two HT6E columns) are used in series. The injected volume of the polymer specimen solution is 100 μl. The detector is a WATERS 2410 differential refractometer and its associated software, for handling the chromatograph data, is the WATERS MILLENIUM system. The calculated average molecular weights are relative to a calibration curve obtained with polystirene standards.

Unsaturated TPS elastomers, such as for example SB, SBS, SBBS, SIS or SBIS, are well known and commercially available, for example from the company Kraton under the name “Kraton D” (e.g. the products D1161, D1118, D1116, D1163 in the case of SB, SIS and SBS elastomers), from the company Dynasol under the name “Calprene” (e.g. the products C405, C411 and C412 in the case of SBS elastomers) or else from the company Asahi under the name “Tuftec” (e.g. the product P1500 in the case of an SBBS elastomer).

The glass transition temperature of the above thermoplastic polymers (Tg₁ and Tg₂) is measured, in a known manner, by DSC (Differential Scanning Calorimetry), for example and except for different indications specified in the present application, according to the ASTM D3418 (1999) Standard.

FIG. 1 appended hereto shows very schematically (without being drawn to a specific scale), in cross section, a first example of a composite reinforcer suitable for the tire according to the invention. This composite reinforcer denoted by R-1 consists of a reinforcing thread (10) consisting of a unitary filament or monofilament having a relatively large diameter (for example between 0.10 and 0.50 mm), for example made of carbon steel, which is covered with a layer (11) comprising on the one hand a thermoplastic polymer having a positive glass transition temperature (Tg₁), for example made of a polyamide or a polyester, and on the other hand an unsaturated TPS elastomer, for example SB, SBS, SBBS, SIS or SBIS, having a negative glass transition temperature (Tg₂); the minimum thickness of this layer is denoted by Eₘ in this FIG. 1.

FIG. 2 shows schematically, in cross section, a second example of a composite reinforcer suitable for the tire according to the invention. This composite reinforcer denoted R-2 consists of a reinforcing thread (20) consisting in fact of two unitary filaments or monofilaments (20a, 20b) of relatively large diameter (for example between 0.10 and 0.50 mm) twisted or cabled together, for example made of carbon steel. The reinforcing thread (20) is covered with a layer (21) with a minimum thickness Eₘ, comprising on the one hand a thermoplastic polymer having a positive glass transition temperature (Tg₁), for example made of a polyamide or a polyester, and on the other hand an unsaturated TPS elastomer, for example SB, SBS, SBBS, SIS or SBIS, having a negative glass transition temperature (Tg₂).

FIG. 3 shows schematically, in cross section, another example of a composite reinforcer suitable for the tire according to the invention. This composite reinforcer denoted by R-3 consists of three reinforcing threads (30) each consisting of two monofilaments (30a, 30b) of relatively large diameter (for example between 0.10 and 0.50 mm) twisted or cabled together, for example made or steel or carbon. The assembly formed by for example the three aligned reinforcing threads (30) is covered with a layer (31) comprising on the one hand a thermoplastic polymer having a positive glass transition temperature (Tg₁), for example made of a polyamide or a polyester, and on the other hand an unsaturated TPS elastomer, for example SB, SBS, SBBS, SIS or SBIS, having a negative glass transition temperature (Tg₂).

FIG. 4 shows schematically, again in cross section, another example of a composite reinforcer suitable for the tire according to the invention. This composite reinforcer R-4 comprises a reinforcing thread (40) consisting of a steel cord of 1+6 construction, with a central wire or core wire (41a) and six filaments (41b) of the same diameter that are wound together in a helix around the central wire. This reinforcing thread or cord (40) is covered with a layer (42) of a polymer composition comprising on the one hand a polyamide and on the other hand an SBS elastomer.

In the composite reinforcers of the tires according to the invention, such as those shown schematically for example in the aforementioned FIGS. 1 to 4, the minimum thickness Eₘ of the sheath surrounding the reinforcing thread or threads may vary very widely depending on the particular production conditions of the invention. It is preferably between 1 μm and 2 mm, more preferably between 10 μm and 1 mm.

If several reinforcing threads (especially several cords) are used, the coating layer or sheath may be deposited individually on each of the reinforcing threads (especially on each of the cords) (as a reminder, these reinforcing threads may or may not be unitary), as illustrated for example in FIGS. 1, 2 and 4 commented upon above, or may also be deposited collectively on several reinforcing threads (especially on several cords) appropriately arranged, for example aligned along a main direction, as illustrated for example in FIG. 3.

The composite reinforcer of the tire of the invention is produced by a specific process comprising at least the step according to which at least one (i.e. one or more) reinforcing thread is subjected to a sheathing operation, preferably by passing through an extrusion head, for sheathing with the layer of thermoplastic polymer composition described above comprising the thermoplastic polymer having a positive glass transition temperature (Tg₁) and the unsaturated thermoplastic stirene elastomer having a negative glass transition temperature (Tg₂).

The sheathing step above is carried out, in a manner known to those skilled in the art, continuously in line. For example, it simply consists in making the reinforcing thread pass through dies of suitable diameter in an extrusion head heated to an appropriate temperature.

According to a preferred embodiment, the reinforcing thread or threads are preheated, for example by induction heating or by IR radiation, before passing into the extrusion head. On exiting the extrusion head, the reinforcing thread or threads thus sheathed are then cooled sufficiently for the polymer layer to solidify, for example using cold air or another gas, or by the thread(s) passing through a water bath followed by a drying step.

The composite reinforcer thus obtained may optionally undergo a heat treatment directly after extrusion or subsequently after cooling.

As an example, in order to obtain a sheathed reinforcing thread having a total diameter of about 1 mm, a reinforcing thread with a diameter of about 0.6 mm, for example a metal cord consisting simply of two individual monofilaments of 0.3 mm diameter twisted together (as for example illustrated in FIG. 2) is covered with a layer of a polyamide 11 and SBS or SB elastomer composition (weight ratio 85/15), having a maximum thickness equal to about 0.4 mm, on an extrusion/sheathing line comprising two dies, a first die (counter-die or upstream die) having a diameter equal to about 0.65 mm and a second die (or downstream die) having a diameter equal to about 0.95 mm, both dies being placed in an extrusion head heated to about 210° C. The mixture of polyamide and TPS elastomer, which melts at a temperature of 210° C. in the extruder, thus covers the cord on passing through the sheathing head, at a thread run speed typically several tens of m/min for an extrusion pump rate typically of several tens of g/min. On exiting this sheathing die, the cord may be immersed in a tank filled with cold water, for cooling before the take-up reel is passed into an oven for drying.

For the sheathing step described above, the cord (reinforcing thread) is advantageously preheated, for example by passing through an HF generator or through a heating tunnel, before passing into the extrusion head.

After this sheathing operation, i.e. directly on leaving the sheathing head, the composite reinforcer may, for example, pass through a tunnel oven, for example several metres in length, in order to undergo therein a heat treatment in air. This treatment temperature is for example between 150° C. and 300° C., for treatment times of a few seconds to a few minutes depending on the case (for example between 10 s and 10 min), it being understood that the duration of the treatment will be shorter the higher the temperature and that the heat treatment necessarily must not lead to the thermoplastic materials used remelting or even excessively softening. The composite reinforcer according to the invention thus completed is advantageously cooled, for example in air, so as to avoid undesirable sticking problems while it is being wound onto the final take-up reel.

Where appropriate, a person skilled in the art will know how to adjust the temperature and the duration of the optional heat treatment above according to the particular operating conditions of the invention, especially according to the exact nature of the composite reinforcer manufactured, in particular according to whether the treatment is on monofilaments taken individually, cords consisting of several monofilaments or groups of such monofilaments or cords, such as strips. In particular, a person skilled in the art will have the advantage of varying the treatment temperature and treatment time so as to find, by successive approximations, the operating conditions giving the best adhesion results for each particular embodiment of the invention.

The steps of the process that have been described above may advantageously be supplemented with a final treatment for three-dimensionally crosslinking the reinforcer, in order to further increase the intrinsic cohesion of its sheath, especially if this composite reinforcer is intended for being eventually used at a relatively high temperature, typically above 100° C.

This crosslinking may be carried out by any known means, for example by physical crosslinking means such as ion or electron bombardment, or by chemical crosslinking means, for example by incorporating a crosslinking agent (for example linseed oil) into the thermoplastic polymer and TPS elastomer composition, for example while it is being extruded, or else by incorporating a vulcanizing system (i.e. a sulphur-based crosslinking system) into this composition.

Crosslinking may also take place, during curing of the pneumatic tires that the composite reinforcer according to the invention is intended to reinforce, by means of the intrinsic crosslinking system present in the diene rubber compositions used for making such tires and coming into contact with the composite reinforcer according to the invention.

The composite reinforcer above can be used directly, that is to say without requiring any additional adhesive system, as reinforcing element in a pneumatic tire. Advantageously, it may be used to reinforce pneumatic tires for all types of vehicle, in particular for passenger vehicles or industrial vehicles such as heavy vehicles.

As an example, FIG. 5 appended hereto shows very schematically (without being drawn to a specific scale) a radial section through a pneumatic tire according to the invention for a passenger vehicle.

This pneumatic tire 1 comprises a crown 2 reinforced by a crown reinforcement or belt 6, two sidewalls 3 and two beads 4, each of these beads 4 being reinforced with a bead wire 5. The crown 2 is surmounted by a tread (not shown in this schematic figure). A carcass reinforcement 7 is wound around the two bead wires 5 in each bead 4, the upturn 8 of this reinforcement 7 lying for example towards the outside of the tire 1, which here is shown fitted onto its rim 9. The carcass reinforcement 7 consists, as is known per se of at least one ply reinforced by cords, called “radial” cords, for example textile or metal cords, that is to say that these cords are arranged practically parallel to one another and extend from one bead to the other so as to make an angle of between 80° and 90° with the median circumferential plane (the plane perpendicular to the rotation axis of the tire, which is located at mid-distance from the two beads 4 and passes through the middle of the crown reinforcement 6).

This pneumatic tire 1 of the invention has for example the essential feature that at least one of the crown or carcass reinforcement thereof comprises a composite reinforcer as described above. According to another possible embodiment of the invention, it is, for example, the bead wires 5 that could be made from this composite reinforcer.

### EMBODIMENT OF THE INVENTION

### Trial 1—Composite Reinforcer Manufacture

Composite reinforcers suitable for the tires according to the invention were firstly manufactured in the following manner. The starting reinforcing thread was a steel cord for pneumatic tires, made of standard steel (having a carbon content of 0.7% by weight), in 1×2 construction consisting of two individual threads or monofilaments 0.30 mm in diameter twisted together with a helix pitch of 10 mm. Cord diameter was 0.6 mm.

This cord was covered with a mixture on the one hand of polyamide 11 (Rilsen BESNO P40TL from the company Arkema; Tₘ equal to about 180° C.) and on the other hand of SBS or SB (respectively D1155 and D1118 from the company Kraton) on an extrusion-sheathing line by passing it through an extrusion head heated to a temperature of 210° C. and comprising two dies—an upstream die 0.63 mm in diameter and a downstream die 0.92 mm in diameter. The thermoplastic mixture consisting of polyamide 11 (pump rate of about 51 g/min) and SBS or SB (pump rate of about 9 g/min) is heated to a temperature of 210° C. and thus covered the thread (preheated to about 174° C. by passing it through an HF generator) running at a speed of 60 m/min. On leaving the sheathing head, the composite reinforcer obtained was continuously run through a cooling tank filled with water at 5° C., in order for its thermoplastic sheath to be cooled, before being dried using an air nozzle.

The glass transition temperatures Tg₁ and Tg₂ of the two types of polymers used above were equal to about +45° C. and −95° C. respectively (for example measured according to the following operating procedure: 822-2 DSC instrument from Mettler Toledo; helium atmosphere; specimens preheated from room temperature (20° C.) to 100° C. (at 20° C./min) and then rapidly cooled down to −140° C., before finally recording the DSC curve from −140° C. to +250° C. at 20° C./min).

After this sheathing operation, in these examples, the assembly underwent a heat treatment for a time of about 100 s, by passing it through a tunnel oven at 3 m/min in an ambient atmosphere (air), heated to a temperature of 270° C. This resulted in composite reinforcements suitable for the tires according to the invention (the reinforcements R-2 as shown schematically in FIG. 2), consisting of the initial steel cord sheathed with its layer of polyamide and elastomer (SBS or SB), the adhesive properties of which are optimal.

To determine the best operating conditions for the heat treatment in the above trial, a range of temperatures from 160° C. to 280° C., for four treatment times (50 s, 100 s, 200 s and 400 s), was examined beforehand.

### Trial 2—Adhesion Tests

The quality of the bond between the rubber and the composite reinforcers manufactured above was then assessed by a test in which the force needed to extract the reinforcers from a vulcanized rubber composition, also called a vulcanizate, was measured. This rubber composition was a conventional composition used for the calendering of metal tire belt plies, based on natural rubber, carbon black and standard additives.

The vulcanizate was a rubber block consisting of two sheaths measuring 200 mm by 4.5 mm and with a thickness of 3.5 mm, applied against each other before curing (the thickness of the resulting block was then 7 mm). It was during the conduction of this block that the composite reinforcers (15 strands in total) were imprisoned between the two rubber sheets in the uncured state, an equal distance apart and with one end of each composite reinforcer projecting on either side of these sheets an amount sufficient for the subsequent tensile test.

The block containing the reinforcers was then placed in a suitable mould and then cured under pressure. The curing temperature and the curing time, left to the discretion of a person skilled in the art, were adapted to the intended test conditions. For example, in the present case, the block was cured at 160° C. for 15 minutes under a pressure of 16 bar.

After being cured, the specimen, thus consisting of the vulcanized block and the 15 reinforcers, was placed between the jaws of a suitable tensile testing machine so as to pull each reinforcer individually out of the rubber, at a given pull rate and a given temperature (for example, in the present case, at 50 mm/min and 100° C. respectively). The adhesion levels were characterized by measuring the pull-out force (denoted by Fₘₐₓ) for pulling the reinforcers out of the specimen (this being an average over 15 tensile tests).

It was found that the composite reinforcer according to the invention, despite the fact that it contains no RFL adhesive (or any other adhesive), had a high pull-out force Fₘₐₓ equal to about 52% (SB elastomer) or 57% (SBS elastomer) of the control pull-out force measured on a control composite reinforcer sheathed simply with polyamide 11 and bonded using a conventional RFL adhesive, which already constitutes a remarkable result for a person skilled in the art.

Under the same conditions, a control composite reinforcer sheathed simply with polyamide 11 (without SBS elastomer) but containing no RFL adhesive (or any other adhesive), showed no adhesion to the rubber (practically zero pull-out force).

Additional trials have also demonstrated that the use of the unsaturated TPS elastomer (SB or SBS), not as the constituent of the sheathing layer but as adhesive incorporated into the rubber calendering composition (and therefore always in contact with the composite reinforcer) provided no adhesive contribution.

Consequently, the composite reinforcer according to the invention, owing to its self-adhesive character, constitutes a particularly useful and entirely credible alternative, on account of the adhesion levels obtained, to the composite reinforcers of the prior art that are sheathed with a thermoplastic material such as a polyamide or polyester which require, as is known, the use of an RFL adhesive to ensure that they adhere to the rubber.

1. A pneumatic tire comprising a composite reinforcer comprising:
one or more reinforcing thread(s);
covering said thread, individually each thread or collectively several threads, a layer of a thermoplastic polymer composition comprising on the one hand a thermoplastic polymer, the glass transition temperature of which is positive, on the other hand an unsaturated thermoplastic stirene elastomer, the glass transition temperature of which is negative.

2. The tire according to claim 1, wherein the glass transition temperature of the thermoplastic polymer is greater than +20° C.

3. The tire according to claim 1, wherein the glass transition temperature of the unsaturated thermoplastic stirene elastomer is less than −20° C.

4. The tire according to claim 1, wherein the difference in glass transition temperature between the thermoplastic polymer and the unsaturated thermoplastic stirene elastomer is greater than 60° C.

5. The tire according to claim 1, wherein the thermoplastic polymer is an aliphatic polyamide or a polyester.

6. The tire according to claim 5, wherein the thermoplastic polymer is a polyamide 6 or a polyamide 11.

7. The tire according to claim 1, wherein the thermoplastic elastomer is a copolymer comprising stirene blocks and diene blocks.

8. The tire according to claim 7, wherein the diene blocks are isoprene or butadiene blocks.

9. The tire according to claim 8, wherein the thermoplastic elastomer is selected within the group consisting of stirene/butadiene (SB), stirene/isoprene (SI), stirene/butadiene/butylene (SBB), stirene/butadiene/isoprene (SBI), stirene/butadiene/stirene (SBS), stirene/butadiene/butylene/stirene (SBBS), stirene/isoprene/stirene (SIS), stirene/butadiene/isoprene/stirene (SBIS) block copolymers and blends of these copolymers.

10. The tire according to claim 9, wherein the thermoplastic elastomer is an SBS or SIS copolymer, preferably an SBS copolymer.

11. The tire according to claim 1, wherein the thermoplastic elastomer comprises between 5 and 50% stirene by weight.

12. The tire according to claim 1, wherein the minimum thickness of the layer is between 1 μm and 2 mm.

13. The tire according to claim 1, wherein the reinforcing thread is a metal wire.

14. The tire according to claim 13, wherein the metal wire is a carbon steel wire.
